(19) United States
(12) Patent Application Publication
(10) Pub. No.: US 2026/0086581 A1
(43) Pub. Date: Mar. 26, 2026

(54) COMPRESSED AIR DELIVERY SYSTEM

(71) Applicants: Jason Stein, Bedford, NH (US); Muamer Stitkovac, Manchester, NH (US)

(72) Inventors: Jason Stein, Bedford, NH (US); Muamer Stitkovac, Manchester, NH (US)

(73) Assignee: Airgo, LLC, Bedford, NH (US)

(21) Appl. No.: 19/340,784

(22) Filed: Sep. 25, 2025

Related U.S. Application Data
(60) Provisional application No. 63/699,124, filed on Sep. 25, 2024.

(51) Int. Cl. G05D 7/06; F17D 1/04

(52) U.S. Cl. CPC G05D 7/0635; F17D 1/04

(57) ABSTRACT

A compressed air delivery system includes a source of pressurized air and a piping system adapted to deliver pressurized air from the source of pressurized air to a compressed air outlet in or accessible from a workstation. A pneumatic object in or accessible from the workstation utilizes compressed air and is connectable to the compressed air outlet. A leak reduction system includes a workstation use detector, a controller, and a compressed air outlet valve moveable between an open position where compressed air flows through the compressed air outlet and a closed position where compressed air does not flow through the compressed air outlet. The workstation use detector provides a workstation use signal related to whether or not the workstation is in use to the controller, and wherein the controller controls operation of the compressed air outlet valve in response to the signal.

### PRIORITY

The present application claims the benefit of domestic priority based on United States Provisional Patent Application 63/699,124 filed on Sep. 25, 2024, the entirety of which is incorporated herein by reference.

### BACKGROUND

A wide range of commercial facilities utilize compressed air for various operations. For example, compressed air can be used in industrial settings to power or operate pneumatic equipment, in garages to inflate tires and/or operate air tools, in hospitals to provide air for breathing assistance and/or to power surgical tools, and in any number of settings for other purposes, such as cleaning dust and debris.

Often a commercial facility that uses compressed air will use a compressed air piping system where one or more central air compressors compress air that is then delivered through pipes to one or more compressed air outlets in one or more workstations within the commercial facility. In the workstation, one end of a hose is connected to one of the compressed air outlets so that compressed air can be delivered through the hose to the other end of the hose, which can be connected to a dispenser, a piece of pneumatic equipment, and/or the like. A hand operated manual valve can be provided in some systems in the piping in proximity to an outlet so that the outlet can be shut off so that compressed air does not flow through the outlet when the hose is not connected to the outlet or when the outlet is otherwise not needed. However, such manual valves rely on operator action and are often left open, allowing compressed air to remain in hoses and equipment when not in use.

While the system of piping from the compressor to the one or more outlets is generally robust, the same cannot always be said for the hose and its connectors within or in proximity to the workstation, and leaks in this area are common. To complicate matters, the leaks can be difficult to detect and/or pinpoint since they often cannot be seen or heard. Air leaks cause the one or more air compressors to turn on more frequently than would be needed without the leaks, thereby wasting compressed air and the energy used to power the one or more air compressors more than is necessary. For commercial facilities with multiple workstations and/or with multiple outlets within a workstation, the unnecessary operation of the one or more air compressors due to the leaks can quickly add up to a significant amount of wasted energy. For example, a pneumatic robot may have over a dozen hose connections all having the potential for leaks. Another example is pneumatic ratchets that are used in tire changing businesses, which are typically strewn about on the floor and heavy leaks are common. It has been estimated that air compressors use more than 10% of the world's electricity. Accordingly, more efficient use of air compressors can have a significant impact on reducing energy consumption.

Facilities have tried several methods of reducing the loss of compressed air from leaks. The most common remedy is to try and locate and fix the leaks. However, the leaks are difficult, time consuming, and expensive to locate. Often by the time a leak is found and repaired, more leaks have developed. Another solution facilities have tried is to hire a company to analyze air usage across shifts, days of the week, etc. and optimize the air pressure to the minimum that's needed. In addition to the expense, another disadvantage of this is that most facilities' needs are not static, and the air requirements for operation change over time and/or from workstation to workstation. This can hinder operation and/or require constant and complicated studying, measuring, and adjusting of air pressures. Even then, the leaks remain and remain costly. Thus, existing approaches either fail to prevent downstream leaks or place undue reliance on operator intervention.

Therefore, there is a need for an improved compressed air delivery system. There is a further need for an improved compressed air delivery system that reduces energy consumption caused by compressed air leaks. There is a further need for a compressed air delivery system that automatically delivers compressed air when a workstation is in need of compressed air and/or automatically shuts off delivery of compressed air when a workstation is not in need of compressed air.

### SUMMARY

The present invention satisfies one or more of these needs. In one aspect of the invention, an improved compressed air delivery system is provided.

In another aspect of the invention, an improved compressed air delivery system reduces energy consumption caused by air leaks.

In another aspect of the invention, a compressed air delivery system automatically delivers compressed air when a workstation is in use or is in need of compressed air and/or shuts off delivery of compressed air when a workstation is not in use or in need of compressed air.

In another aspect of the invention, a method of delivering compressed air comprises providing a compressed air delivery system as described herein and using the compressed air delivery system as described herein.

In another aspect of the invention a compressed air delivery system comprises a leak reduction system that automatically shuts off the supply of compressed air to a workstation when the workstation is not in use.

In another aspect of the invention a compressed air delivery system comprises a leak reduction system that automatically shuts off the supply of compressed air to a workstation when the workstation is not in use, wherein the leak reduction system comprises a workstation use detector, a controller, and a compressed air outlet valve that can be opened and closed in response to a workstation use signal from the workstation use detector.

In another aspect of the invention a compressed air delivery system comprises a leak reduction system that automatically shuts off the supply of compressed air to a workstation when the workstation is not in use, wherein the leak reduction system comprises a workstation use detector, a controller, and a compressed air valve that can be opened and closed in response to a signal from the workstation use detector, wherein the workstation use detector comprises an equipment operation sensing detector.

In another aspect of the invention a compressed air delivery system comprises a leak reduction system that automatically shuts off the supply of compressed air to a workstation when the workstation is not in use, wherein the leak reduction system comprises a workstation use detector, a controller, and a compressed air valve that can be opened and closed in response to a signal from the workstation use detector, wherein the workstation use detector comprises an equipment operation sensing detector and an indicator for a position on the equipment to tap or otherwise cause to move to open the compressed air valve.

In another aspect of the invention a compressed air delivery system comprises a leak reduction system that automatically shuts off the supply of compressed air to a workstation when the workstation is not in use, and wherein the leak reduction system comprises a workstation use detector, a controller, and a compressed air valve that can be opened and closed in response to a signal from the workstation use detector, and wherein the workstation use detector comprises an air hose movement sensing detector.

In another aspect of the invention a compressed air delivery system comprises a leak reduction system that automatically shuts off the supply of compressed air to a workstation when the workstation is not in use, wherein the leak reduction system comprises a workstation use detector, a controller, and a compressed air valve that can be opened and closed in response to a signal from the workstation use detector, and wherein the workstation use detector comprises a presence detector.

In another aspect of the invention, a method of delivering compressed air to a workstation comprises providing a compressed air outlet to a workstation, the compressed air outlet having a compressed air outlet valve, detecting whether the workstation is in use; if not in use, automatically closing the compressed air outlet valve.

In another aspect of the invention, a method of delivering compressed air to a workstation comprises providing a compressed air outlet to a workstation, the compressed air outlet having a compressed air outlet valve, detecting whether the workstation is in use; if not in use, automatically closing the compressed air outlet valve after a period of nonuse.

In another aspect of the invention, a method of delivering compressed air to a workstation comprises providing a compressed air outlet to a workstation, the compressed air outlet having a compressed air outlet valve, detecting whether the workstation is in use; if not in use, automatically closing the compressed air outlet valve after a period of nonuse, wherein the period is about 30 minutes.

In another aspect of the invention, a method of delivering compressed air to a workstation comprises providing a compressed air outlet to a workstation, the compressed air outlet having a compressed air outlet valve, detecting whether the workstation is in use; if not in use, automatically closing the compressed air outlet valve, and automatically opening the compressed air outlet valve when the workstation is again being used.

In another aspect of the invention, a method of delivering compressed air to a workstation comprises providing a compressed air outlet to a workstation, the compressed air outlet having a compressed air outlet valve, detecting whether the workstation is in use; if not in use, automatically closing the compressed air outlet valve, wherein the detecting step comprises detecting whether or not a piece of equipment in or near the workstation is operating.

In another aspect of the invention, a method of delivering compressed air to a workstation comprises providing a compressed air outlet to a workstation, the compressed air outlet having a compressed air outlet valve, detecting whether the workstation is in use; if not in use, automatically closing the compressed air outlet valve, wherein the detecting step comprises detecting whether or not an air hose has been moved.

In another aspect of the invention, a method of delivering compressed air to a workstation comprises providing a compressed air outlet to a workstation, the compressed air outlet having a compressed air outlet valve, detecting whether the workstation is in use; if not in use, automatically closing the compressed air outlet valve, wherein the detecting step comprises detecting whether or not a user is present in the workspace.

In another aspect of the invention, an improved fluid delivery system is provided for delivering air, liquid, and/or gas.

In another aspect of the invention, an improved fluid delivery system reduces energy and/or resource consumption caused by fluid leaks.

In another aspect of the invention, a fluid delivery system automatically delivers fluid when a workstation is in need of fluid and/or shuts off delivery of fluid when a workstation is not in need of fluid.

In another aspect of the invention, a method of delivering fluid comprises providing a fluid delivery system as described herein and using the fluid delivery system as described herein.

In another aspect of the invention, a compressed air delivery system comprises a source of pressurized air; a piping system adapted to deliver pressurized air from the source of pressurized air to a compressed air outlet in or accessible from a workstation; a pneumatic object in or accessible from the workstation, wherein the pneumatic object utilizes compressed air and is connectable to the compressed air outlet; and a leak reduction system, the leak reduction system comprising a workstation use detector, a controller, and a compressed air outlet valve adapted to be moveable between an open position where compressed air flows through the compressed air outlet and a closed position where compressed air does not flow through the compressed air outlet, wherein the workstation use detector provides a workstation use signal related to whether or not the workstation is in use to the controller, and wherein the controller controls operation of the compressed air outlet valve in response to the signal.

In another aspect of the invention, a leak reduction system is provided for use with a compressed air delivery system comprising a source of pressurized air; a piping system adapted to deliver pressurized air from the source of pressurized air to a workstation; a compressed air outlet in or near the workstation; a pneumatic object that utilizes compressed air, the pneumatic object being connectable to the compressed air outlet. the leak reduction system comprising a workstation use detector, a controller, and a compressed air outlet valve adapted to be moveable between an open position where compressed air is allowed to flow through the compressed air outlet and a closed position where compressed air is not permitted to flow through the compressed air outlet, wherein the workstation use detector provides a workstation use signal related to whether or not the workstation is in use to the controller, and wherein the controller controls operation of the compressed air outlet valve in response to the signal.

In another aspect of the invention, a method of reducing leaks in a compressed air delivery system in which compressed air is delivered to a workstation including a pneumatic object that utilizes compressed air, comprises detecting a condition related to workstation use; determining whether or not the workstation is in use from the detected condition; if the workstation is determined to be in use, allowing compressed air to flow to the pneumatic object; and if the workstation is determined to not be in use, preventing compressed air from flowing to the pneumatic object.

In another aspect of the invention, a compressed air delivery system comprises a source of pressurized air; a piping system adapted to deliver pressurized air from the source of pressurized air to a workstation; a compressed air outlet in or near the workstation; an object that utilizes compressed air; an air hose connectable to the compressed air outlet and to the object and adapted to deliver compressed air from the compressed air outlet to the object; and a leak reduction system, the leak reduction system comprising a workstation use detector, a controller, and a compressed air outlet valve adapted to be moveable between an open position where compressed air flows through the compressed air outlet and a closed position where compressed air does not flow through the compressed air outlet, wherein the workstation use detector provides a workstation use signal related to whether or not the workstation is in use to the controller, and wherein the controller controls operation of the compressed air outlet valve in response to the signal.

In another aspect of the invention, a leak reduction system is provided for use with a compressed air delivery system comprising a source of pressurized air; a piping system adapted to deliver pressurized air from the source of pressurized air to a workstation; a compressed air outlet in or near the workstation; an object that utilizes compressed air; and an air hose connectable to the compressed air outlet and to the object and adapted to deliver compressed air from the compressed air outlet to the object, the leak reduction system comprising a workstation use detector, a controller, and a compressed air outlet valve adapted to be moveable between an open position where compressed air is allowed to flow through the compressed air outlet and a closed position where compressed air is not permitted to flow through the compressed air outlet, wherein the workstation use detector provides a workstation use signal related to whether or not the workstation is in use to the controller, and wherein the controller controls operation of the compressed air outlet valve in response to the signal.

In another aspect of the invention, a method of reducing leaks in a compressed air delivery system comprises providing a source of pressurized air; delivering pressurized air from the source of pressurized air to a workstation, wherein the workstation includes an object that utilizes compressed air; providing a compressed air outlet in or near the workstation; providing an air hose connected to the compressed air outlet and to the object; detecting a condition related to workstation use; determining whether or not the workstation is in use from the detected condition; if the workstation is determined to be in use, allowing compressed air to flow through the compressed air outlet; and if the workstation is determined to not be in use, preventing compressed air from flowing through the compressed air outlet.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic diagram of a compressed air delivery system according to the invention;

FIG. 2A is a schematic diagram of a version of a leak reduction system of the compressed air delivery system of FIG. 1;

FIG. 2B is a schematic diagram of another version of a leak reduction system of the compressed air deliver system of FIG. 1;

FIG. 2C is a schematic diagram of another version of a leak reduction system of the compressed air deliver system of FIG. 1;

FIG. 2D is a schematic diagram of another version of a leak reduction system of the compressed air deliver system of FIG. 1;

FIG. 3 is a schematic flow diagram of a version of a compressed air delivery process for the compressed air delivery system of FIG. 1;

FIG. 4 is a schematic flow diagram of another version of a compressed air delivery process for the compressed air delivery system of FIG. 1;

FIG. 5 is a schematic flow diagram of another version of a compressed air delivery process for the compressed air delivery system of FIG. 1;

FIG. 6 is a schematic flow diagram of another version of a compressed air delivery process for the compressed air delivery system of FIG. 1;

FIG. 7 is a schematic flow diagram of another version of a compressed air delivery process for the compressed air delivery system of FIG. 1;

FIG. 8 is a schematic flow diagram of another version of a compressed air delivery process for the compressed air delivery system of FIG. 1;

FIG. 9 is a schematic flow diagram of another version of a compressed air delivery process for the compressed air delivery system of FIG. 1;

FIG. 10A is a schematic diagram of another version of a leak reduction system of the compressed air delivery system of FIG. 1;

FIG. 10B is a schematic diagram of another version of a leak reduction system of the compressed air delivery system of FIG. 1;

FIG. 11A is a schematic diagram of another version of a leak reduction system of the compressed air delivery system of FIG. 1;

FIG. 11B is a schematic diagram of another version of a leak reduction system of the compressed air delivery system of FIG. 1;

FIG. 12 is a schematic diagram of another version of a leak reduction system of the compressed air delivery system of FIG. 1;

FIG. 13A is a schematic diagram of another version of a leak reduction system of the compressed air delivery system of FIG. 1;

FIG. 13B is a schematic diagram of another version of a leak reduction system of the compressed air delivery system of FIG. 1;

FIG. 14 is a schematic diagram of another version of a leak reduction system of the compressed air delivery system of FIG. 1;

FIG. 15 is a schematic diagram of another version of a leak reduction system of the compressed air delivery system of FIG. 1;

FIG. 16 is a schematic diagram of another version of a compressed air delivery system of the invention;

FIG. 17 is a schematic diagram of another version of a compressed air delivery system of the invention;

FIG. 18 is a schematic diagram of a fluid delivery system according to the invention; and

FIG. 19 is a schematic diagram of another version of a fluid delivery system according to the invention.

### DESCRIPTION

The present invention relates to a fluid delivery system. In particular, the invention relates to a fluid delivery system that reduces energy consumption caused by fluid leaks. Although the invention is illustrated and described in the context of being useful for compressed air delivery, the present invention can be used in other ways, as would be readily apparent to those of ordinary skill in the art. Accordingly, the present invention should not be limited just to the examples and embodiments described herein.

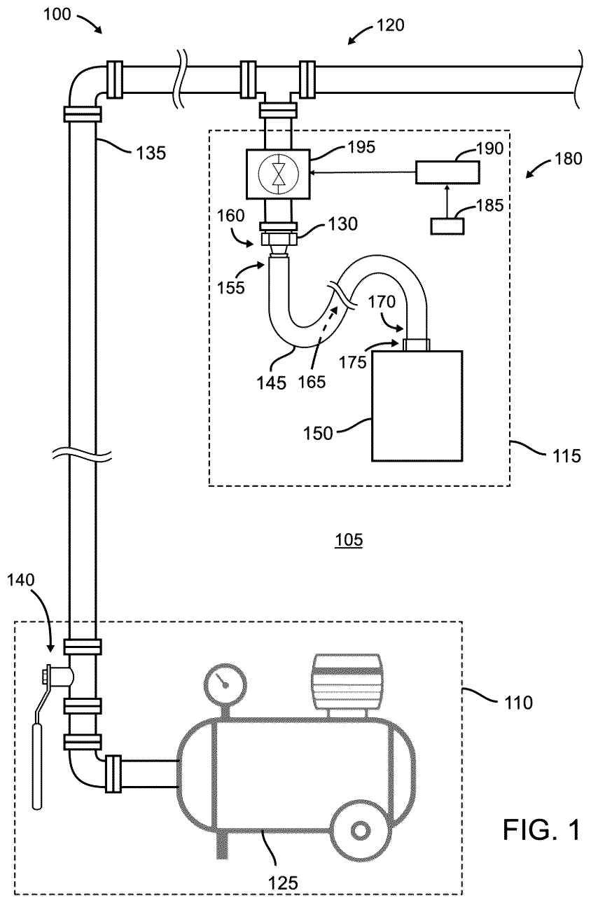

FIG. 1 shows a compressed air delivery system 100 according to one version of the invention. The compressed air delivery system 100 is provided within a facility 105 that utilizes compressed air in operation, such as an industrial facility, garage, shop, hospital or other medical facility, or the like. The compressed air delivery system 100 delivers compressed air from a source of compressed air, such as a central air compression area 110, to one or more workstations 115. A workstation 115 can be any space within the facility where compressed air is used or potentially used for one or more operations within or in proximity to the workstation 115. The workstation 115 can be one of a plurality in a large commercial facility or can be one of a few or even a single workstation in a facility, or in a home, garage, workshop, or the like, and can be as small as a single piece of equipment or as large as an entire factory floor. Examples of workstations include areas of production, processing, robotic, and the like pneumatic machinery in a commercial facility; patient rooms, surgical rooms, emergency rooms, ICU beds, and the like in a medical facility; car or truck stalls in a garage; and anywhere work is otherwise performed where compressed air or other fluid may be needed. Workstations 115 can be, but need not necessarily be, divided from one another, and can in some cases overlap with one another.

The compressed air delivery system 100 includes a piping system 120 that provides compressed air from the central air compression area 110 to one or more workstations 115 in the facility 105. The piping system 120 connects one or more air compressors 125 in the central air compression area 110 to one or more compressed air outlets 130 in or near one or more workstations 115. A system of pipes and pipe connectors or joints 135 form sealed conduits that contain the compressed air and make the compressed air available at the one or more outlets 130. The piping system 120 is typically, but need not necessarily be, made of hard or rigid piping, such as copper, steel, iron, brass, aluminum, PVC, or the like. Because the piping system 120 is a fixed structure that does not need to move or be flexible, the piping system 120 can be robustly constructed so that leaks are minimized. The one or more air compressors 125 compress air so as to maintain the air in the piping system 120 at or above a predetermined pressure. When compressed air is released at a compressed air outlet 130, the pressure of the air within the piping system 120 will drop and/or compressed air from a storage tank will be introduced, and when the pressure drops below the predetermined pressure or the storage tank falls below a predetermined level, the one or more air compressors 125 will automatically begin compressing air to raise the pressure in the piping system 120 to the predetermined level. Accordingly, the more pressurized air that escapes through the one or more compressed air outlets 130, whether intended or unintended, the more power and energy is used by the one or more air compressors 125. A piping system shut off valve 140 may be provided, either in the central air compression area 110 or downstream thereof, to selectively shut off the delivery of the compressed air to the rest of the one or more compressed air outlets 130 when desired, such as when the facility 105 is not in operation or when the piping system 120 is being repaired.

Within or near the workstation 115, an air line, such as an air hose 145 or other soft line or a hard pipe, is used to receive compressed air from a compressed air outlet 130 and deliver the compressed air to an object 150, such as a pneumatic object that utilizes the compressed air. The object 150 can be, for example, a piece of equipment or tool that uses compressed air to operate or can be a nozzle or dispenser that allows a user to selectively release compressed air. The air hose 145 has a first end 155 with a component that cooperates with a compressed air outlet 130 to form an outlet coupler 160 that connects the first end 155 of the air hose 145 to the compressed air outlet 130 in a manner that allows the compressed air to flow through an interior lumen 165 of the air hose 145 to a second end 170 of the air hose 145. The second end 170 of the air hose 145 has a component that cooperates with a component of the object 150 to form an object coupler 175 that connects the second end 170 of the air hose 145 to the object 150 in or near the workstation 115 in a manner that delivers compressed air to the object 150 for the operation of the object 150 and/or for selective dispensing of the compressed air by an operator or other device. The air hose 145, outlet coupler 160, and object coupler 175 can be any conventional and/or commercially available type or any newly developed components. Typically, the air hose 145 will be made of one or more of polyurethane, PVC, rubber, silicone, and the like, and will be equipped with a female outlet connector that receives a male connector component on the compressed air outlet 130 to together form the outlet coupler 160 and a male object connecter that is insertable into a female component on the object 150 to together form the object coupler 175, but the hose and couplers can be any other suitable arrangement. Alternatively, the air hose 145 can be replaced by directly connecting the compressed air outlet 130 to a pneumatic object 150 so that the compressed air outlet 130 becomes a object compressed air inlet.

The compressed air system downstream of the compressed air outlet 130 is more prone to air leaks than the piping system 120 that is upstream of the compressed air outlet 130. The outlet coupler 160 and/or the object coupler 175, which are typically, but not necessarily, designed to be easily releasable, are particularly subject to leaking especially after prolonged use. The air hose 145 due to its flexible nature and the object 150, which often has numerous moving parts, are also susceptible to leaks. The leaks are often unnoticed and can be difficult to locate when they are noticed. Accordingly, the compressed air delivery system 100 of the invention includes a leak reduction system 180 designed to reduce the loss of compressed air from one or more leaks in or near a workstation 115, particularly downstream of a compressed air outlet 130.

As can be seen in the version of FIG. 1, the leak reduction system 180 comprises a workstation use detector 185 that communicates with a controller 190 which controls the operation of a compressed air outlet valve 195 that is positioned and adapted to control whether or not compressed air is delivered to a compressed air outlet 130 from the piping system 120. The compressed air outlet valve 195 is thus responsive to the workstation use detector 185. For example, in one version, the workstation use detector detects a condition in or near the workstation 115 and/or on or near the object 150 or hose 145 and sends a workstation use signal to the controller 190 which makes an assessment as to whether or not the object 150 is in use and/or whether or not the workstation 115 is in need of having compressed air supplied to and available from the compressed air outlet 130. If the compressed air is determined to be unneeded, a signal is sent from the controller 190 to the compressed air outlet valve 195 to cause the compressed air outlet valve 195 to close thereby shutting off the supply of compressed air from the piping system 120 to the compressed air outlet 130. By being shut off, no compressed air is delivered to the air hose 145 or the object 150 when the compressed air is not needed. As a result, there is a reduced loss of compressed air from leaks that exists downstream of the compressed air outlet 130. In the absence of the shut off, compressed air would be present in the air hose 145 and object 150 while the workstation 115 is idle, and a portion of the compressed air will escape through leaks in, for example, the air hose 145, object 150, outlet coupler 160, and/or object coupler 175, and that escaped compressed air will result in the one or more air compressors 125 having to compress more air to compensate for the leaks. By reducing or eliminating the leaks by shutting off the supply of compressed air to the leak-prone regions, the power and energy consumption by the one or more air compressors 125 can be greatly reduced. The leak reduction system 180 thus operates to conserve compressed air in the piping system 120 so that it can be better utilized during productive operation of a workstation 115 rather than being lost to the environment.

The workstation use detector 185 of the leak reduction system 180 of the compressed air delivery system 100 can be any detector or combination of detectors that provide the controller 190 with a workstation use signal related to whether or not a workstation 115 is in use. The workstation use signal can contain sufficient information so that the controller 190 is able to make a determination of whether the workstation 115 and/or an object 150 in or near the workstation 115 is in use or likely to be in use. For example, a workstation 115 can be considered to be in use when a piece of pneumatic equipment is being operated, when an operator is manipulating a piece of equipment within the workstations, such as the air hose 154, when an individual is present in the workstation, when a command is provided by a user that the workstation 115 is to be used, and/or the like. The workstation use signal can be a raw signal that is provided to the controller 190 and the controller can interpret the raw data and make a use determination or the workstation use signal can be a binary signal indicating to the controller 190 that the workstation 115 is either in use or not in use.

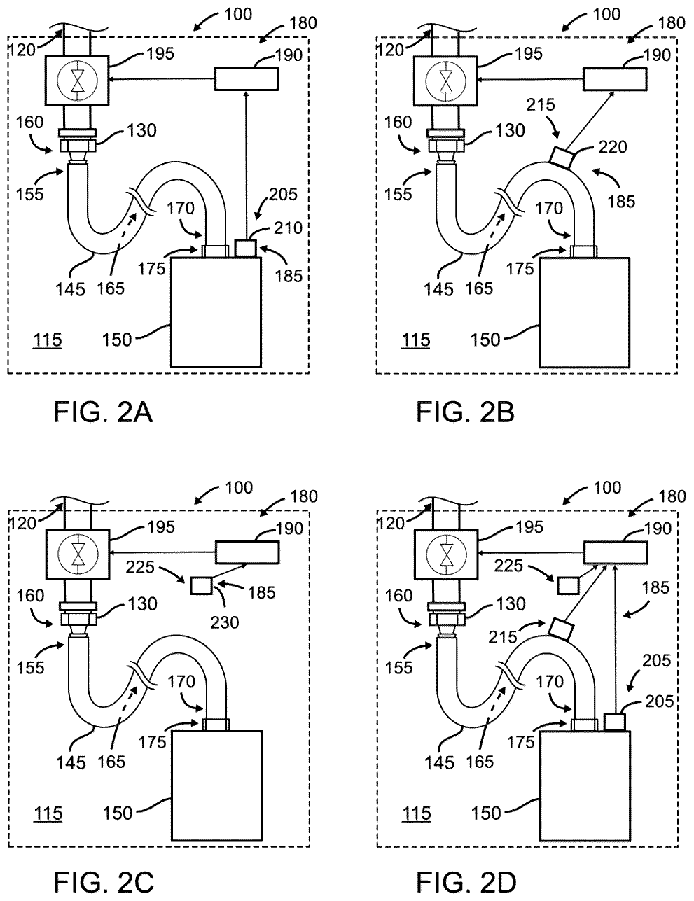

FIG. 2A shows a version of a workstation use detector 185 of the compressed air delivery system 100. FIG. 2A illustrates a workstation use detector 185 in the form of an equipment operation sensing detector 205. In one version, the equipment operation sensing detector 205 comprises an operation sensor 210 that is positioned on or near the object 150, which in the version of FIG. 2A is a piece of equipment or tool that utilizes compressed air to operate and/or during operation. The operation sensor 210 can, for example, be a vibration sensor or accelerometer or any other sensor, such as an ultrasonic, magnetic flux, temperature, humidity, or the like sensor, that detects vibration, movement, and/or operation of the object 150 and provides sufficient information to the controller 190 to enable the controller 190 to determine if the piece of equipment is operating or is not operating. In another version, the equipment operation sensing detector 205 can an on/off switch for the equipment or can be in communication with the on/off switch. When the workstation use detector 185 provides a workstation use signal to the controller 190 indicative of equipment operation, the controller 190 opens or maintains the opening of the compressed air outlet valve 195 so that compressed air can be delivered to the equipment.

FIG. 2B shows another version of a workstation use detector 185 of the compressed air delivery system 100. In FIG. 2B, a workstation use detector 185 is in the form of an air hose movement sensing detector 215. The air hose movement sensing detector provides a workstation use signal related to the movement of the air hose 145. For example, the air hose movement sensing detector 215 can comprise a movement sensor 220 attached to or in proximity to the air hose 145 so that a workstation use signal is generated whenever the air hose 145 is moved or manipulated. The movement sensor 220, which can be a vibration sensor or accelerometer or any other type of movement sensor, such as an optical, ultrasonic, magnetic flux, or the like sensor, generates a workstation use signal indicating to the controller 190 that the air hose 145 is being manipulated by a user in or near the workstation 115. Alternatively, the air hose movement sensing detector can comprise a pressure sensor or a temperature sensor near an end or grippable portion of the air hose 145 that generates a workstation use signal when the air hose 145 has been grasped or otherwise contacted by a user. In this version, the movement or manipulation of the air hose 145 indicates that a user in or near the workstation 115 is in the process of using the compressed air in the air hose 145 or is in the process of preparing to use the compressed air. In one version, by careful placement of the movement sensor 220 on the air hose 145, the movement sensor 220 can also be used to sense the operation of a piece of equipment that the air hose 145 is connected to. When the workstation use detector 185 provides a workstation use signal to the controller 190 indicative of air hose movement, the controller 190 opens or maintains the opening of the compressed air outlet valve 195 so that compressed air can be delivered to the air hose 145.

FIG. 2C shows another version of a workstation use detector 185 of the compressed air delivery system 100. FIG. 2C illustrates a workstation use detector 185 in the form of a user presence sensing detector 225. The user presence sensing detector 225 comprises a presence sensor 230 that senses the presence of a user, such as an operator or other individual, in or near the workstation 115. For example, the presence sensor 230 can be a motion detector, temperature detector, weight detector or the like that is able to sense when someone is present at a particular location and generate a workstation use signal for the controller 190 indicative thereof. Alternatively, the presence sensor 230 can be a detectable signal generator worn or carried by a user of the workstation 115, such as radio frequency identification card or the like. In the version, a user can scan their signal generator or it can be automatically sensed as a way to indicate to the controller 190 that the user is using or preparing to use the compressed air.

FIG. 2D shows a version of a workstation use detector 185 of the compressed air delivery system 100. In the version of FIG. 2D, the workstation use detector comprises a combination of two or more sensors, such as two or more of the types of systems illustrated in FIGS. 2A, 2B, and/or 2C. The combination of a plurality of sensors can be used to provide increased sensitivity or increased assurance for the controller 190. In one version, the different types of sensors can be used for different purposes. For example, one type of sensor, such as a movement or motion detector, can be used to move the compressed air outlet valve 195 from a closed to an open position, whereas a different type of sensor, such as an equipment operating sensor, can be used to maintain the compressed air outlet valve 195 in its open position, as will be further described.

The components of the leak reduction system 180 can be any suitable components, either new or commercially available, assembled in a manner to perform the functions described. For example, the sensors can be specially crafted sensors or commercially available sensors of the type described. The sensors can be positioned within the workstation 115 using any suitable manner of attachment or positioning. For example, an operation sensor 210 can be attached to a piece of equipment by an adhesive, a magnet, screw, bolt, weld, or the like. The operation sensor 210 can be strategically positioned, such as by being positioned on or near a motor, moving part, safety gate, and/or the like. Optionally, for added sensitivity, a plurality of operation sensors 210 can be associated with a piece of equipment with any of the operation sensors 210 being able to trigger a determination of use. The compressed air outlet valve 195 can be any electronically controllable valve or the like that is capable of changing from an open position to a closed position and/or from a closed position to an open position in response to an electronic signal or the like. A commercially available example of such a valve is an electrically actuated two-way ball valve from DynaQuip Controls in St. Claire, MO. Communication between the workstation use detector 185 and the controller 190 and/or between the controller 190 and the compressed air outlet valve 195 can be any suitable manner of electronic communication, such as wires, wifi, radio waves, such as LoRa communication, Bluetooth, or the like. The controller 190 can be any electronic device that is designed to and/or is programmable to be able to receive a signal from a workstation use detector 185, make a determination related to workstation use based on the signal, and communicate a valve position to the compressed air outlet valve 195. The controller 190 can be housed on the workstation use detector 185, on the compressed air outlet valve 195, or can be a separate unit that communicates with each of the workstation use detector 185 and the compressed air outlet valve 195. The controller can range from a hard-wired control board to a computer system, such as an operations control server or a desktop or handheld computer, smartphone, or tablet that has an interface allowing it to be programmed, have features or parameters entered. The controller may also be able to maintain and/or display a history of activities.

In one version, the controller 190 is in the form of one or more customized printed circuit board. In one particular version, the controller is in the form of a pair of printed circuit boards, one on or in proximity to the compressed air outlet valve 195 and one on or in proximity to a workstation use detector 185. The pair of printed circuit boards communicate with one another by suitable technology. The pair is easily installable onto existing and/or conventional compressed air delivery systems to convert them to a compressed air delivery system 100 of the invention. In one version, the printed circuit boards are battery powered and are designed to be low-power consuming and communicate with one another by LoRa technology which allows them to effectively communicate across long distances so that an entire facility can often be covered and in communication. In this particular version, the device to device communication eliminates the need for hubs, gateways, wifi, or the like, which helps to maintain a facility's security and privacy and allows the system to work even when a network is down. Pictures of a system embodying this version can be found in the Appendix at the end of the drawings of the provisional application.

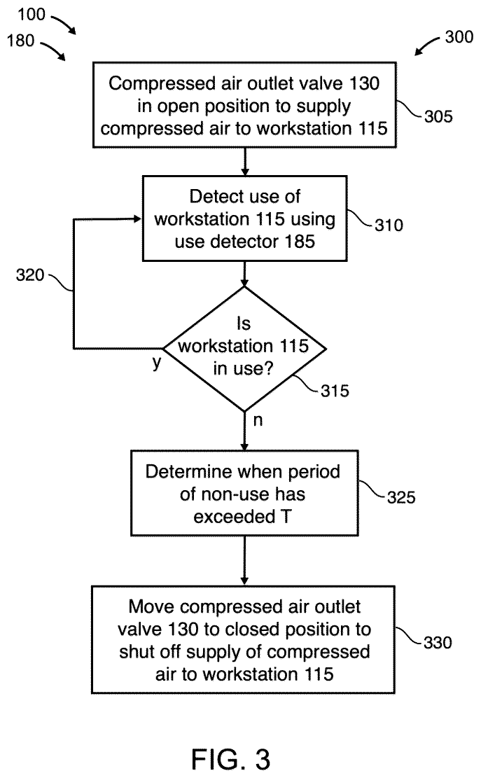

FIG. 3 illustrates an example of a compressed air delivery process 300 that can be performed using the compressed air delivery system 100 of the invention. The compressed air delivery process 300 of FIG. 3 is a process for shutting off the flow of compressed air to a compressed air outlet 130 in response to a stoppage of the use of a workstation 115. In step 305 the compressed air outlet valve 195 is in an open position, and compressed air is supplied to the workstation 115 through the compressed air outlet 130. In step 310, while the compressed air is being made available to the compressed air outlet 130, the workstation use detector 185 detects the use of the workstation 115 and sends a signal indicative of the use to the controller 190. The controller 190, as shown in step 315, receives the signal from the workstation use detector 185 and makes a determination as to whether or not the workstation 115 is being used. If yes, the detection continues 320. In no, the process 300 moves to step 325 where the controller 190 determines if the workstation 115 has been unused for a period T. If the workstation 115 has gone without use for T, then the process 300 proceeds to step 330 and the controller 190 causes the compressed air outlet valve 195 to close and to shut off the supply of compressed air to the compressed air outlet 195. The period T can be any period of time, from 0 seconds to any number of minutes, after which it is desired to shut off the availability of compressed air to the compressed air outlet 130. The value of T can be preselected and built into the system or can be entered into the controller 195 such as by using a computer interface. For example, the period T may be selected to be 1 minute, 15 minutes, 30 minutes, 60 minutes, or any other amount of time, and the selected time will tend to vary based on the type of activity occurring in the workstation 115. In addition, the sensitivity level can be adjustable in the controller 190 so that a threshold level for making a use determination can be adjusted depending on the type of workstation 115 and/or type of equipment or sensors.

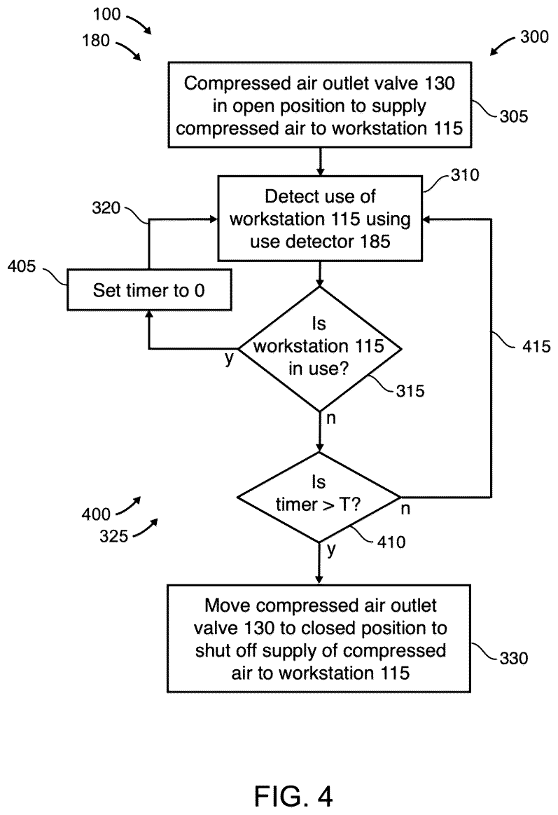

FIG. 4 illustrates a version of a compressed air delivery process 300 which includes a particular version of the step 325 of determining if the workstation 115 has been unused for a period T. This version includes a timing process 400 in which a timer is used. The time can reside in the controller 190, the compressed air outlet valve 195, or elsewhere. In this version, when the workstation 115 is determined to be in use in step 315, the timer is set to zero 405. When the workstation 115 is determined to not be in use in step 315, the timer is checked 410 to see if period T has been exceeded. If it has not, the detection continues 415 until either the workstation 115 is again in use, in which case the timer is reset to zero 405, or until the period T is exceeded at which time the compressed air outlet valve 195 is closed 330. In one particular version of the compressed air delivery system 100, the timer resides or is in communication with the compressed air outlet valve 195. When a signal indicative of use of the workstation 115, such as a signal indicating a vibration is detected, is communicated to the compressed air outlet valve 195, the signal causes the valve to open or remain open and resets the timer to zero. If the timer reaches T without being reset, such as by not receiving any signal indicating use of the workstation 115. the compressed air outlet valve 195 automatically closes shutting down the air to the workstation and/or to a particular piece of equipment that is being monitored. This process thus reduces or eliminates air leaks while the workstation 115 or piece of equipment is not in use.

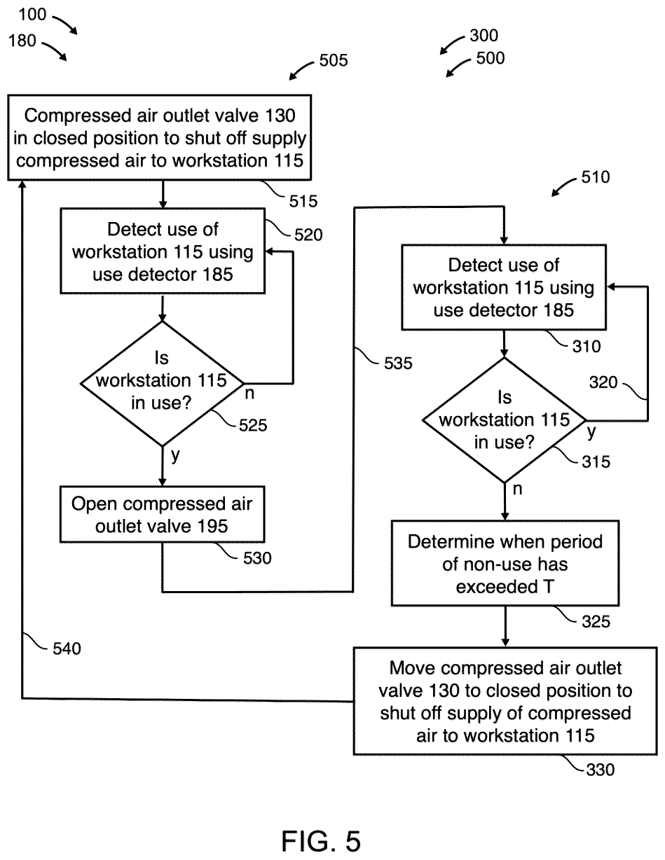

FIG. 5 illustrates another example of a compressed air delivery process 300 that can be performed using the compressed air delivery system 100 of the invention. The compressed air delivery process 300 of FIG. 5 is a process 500 that is useful when a compressed air outlet valve 195 is in a closed position, and includes a startup process 505 for opening the compress air outlet valve 195 when a workstation 115 is to be used and a shut off process 510 for shutting off the flow of compressed air to a compressed air outlet 130 in response to a stoppage of the use of a workstation 115. In this process, the compressed air outlet valve 195 is initially in a closed position 515 when the workstation 115 is idle, unused, or when a particular piece of equipment in the workstation 115 is not being used. The one or more use detectors 185 monitor the workstation 115 and/or equipment 520, and when a use signal is detected 525, the controller 190 causes the compressed air outlet valve 195 to open 530. Once the compressed air outlet valve is open and the workstation 115 is being used, the process 500 moves on 535 to the shut off process 510 which is similar to the version of FIG. 3 whereby the compressed air outlet valve 195 is closed 330 to shut off the supply of compressed air to the compressed air outlet 130 when the workstation 115 and/or piece of equipment is no longer in use. Then, once again in the shut off mode, the process 500 can begin again 540. The process 500 of FIG. 5 can run continuously so that compressed air is provided to the workstation 115 when needed and shut off when not needed.

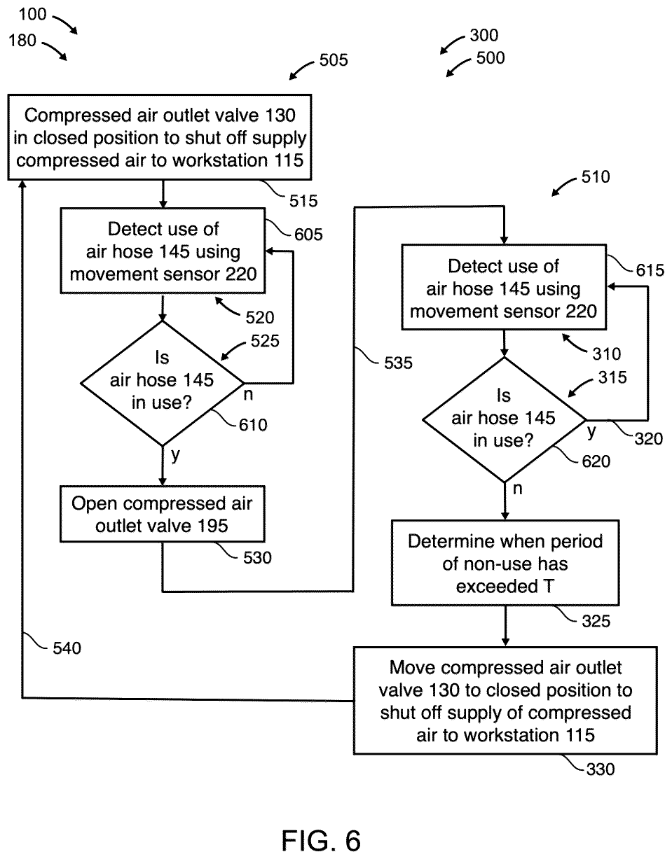

FIG. 6 illustrates a version of a compressed air delivery process 300 that can be performed using the compressed air delivery system 100 of the invention in accordance with the process 500 of FIG. 5. In the version of FIG. 6, the workstation use detector 185 of the compressed air delivery system 100 comprises an air hose movement sensing detector 215 with a movement sensor 220 that is capable of detecting movement 605 of the air hose 145 as an indicator that the workstation is being or is to be used. For example, an operator may pick up the air hose 145 to use compressed air though the air hose 145 and/or may be connecting the air hose to a tool or other piece of equipment. Alternatively, the air hose 145 may be caused to move by movement, such as vibration, of a tool or other piece of equipment the air hose 145 is connected to. When movement of the air hose 145 is detected 610, the compressed air outlet valve 195 is opened so that the supply of compressed air can be passed through the air hose 145. The shut off process 510 for the version of FIG. 6 involves continuing to monitor 615 the movement sensor 220 to determine when the air hose 145 is no longer in use 620 so that the compressed air outlet valve 195 can then be closed 330 to reduce leaks during the idle period.

The version of FIG. 6 has many possible uses. For example, an air hose 145 that is lying on the ground or hanging on a hook or the like can be utilized by a user in the workstation 115 merely by picking up the air hose 145. The movement sensor 220 will detect the movement and cause compressed air to be automatically supplied to the air hose 145. This can be much more convenient for the user than having to manually turn on an outlet whenever the air hose 145 is needed and then turn off the outlet when not needed. Similarly, when an air hose 145 is to be connected to a tool or other piece of equipment, the connection process will cause sufficient movement of the air hose 145 to trigger the compressed air outlet valve 195 to automatically open. In a situation when the air hose 145 is already connected to a piece of equipment, the starting of the operation of the equipment, such as by causing a motor to start up, can cause the air hose to vibrate or otherwise move in a manner that will be detected as a use of the equipment. In the case when compressed air is needed for the piece of equipment to being operating, a user can provide a shake of the air hose 145 or the like to cause the compressed air to begin being supplied.

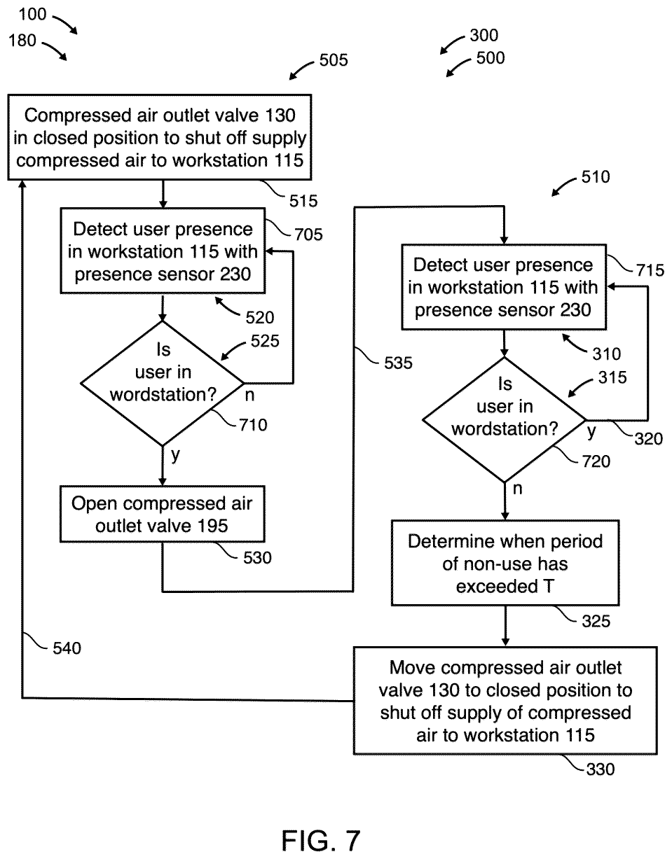

FIG. 7 illustrates another version of a compressed air delivery process 300 that can be performed using the compressed air delivery system 100 of the invention in accordance with the process 500 of FIG. 5. In the version of FIG. 7, the workstation use detector 185 of the compressed air delivery system 100 comprises a user presence sensing detector 225, such as a motion sensor, RFID, weight sensor, or the like, as discussed above, that senses when a user, such as an operator or other individual, is present 705 in a workstation 115. For example, for a particular type of workstation 115 the lack of user's presence in the workstation 115 can be an indication that compressed air is not needed in the workstation 115. With the process of FIG. 7, the compressed air will be automatically made available when there a user becomes present in the workstation. When a user's presence is detected 710, the compressed air outlet valve 195 is opened so that the supply of compressed air can be provided to the compressed air outlet 130 and used in the workstation 115. The shut off process 510 for the version of FIG. 7 involves continuing to monitor 715 the movement sensor 220 to determine when there is no longer a user presence 720 in the workstation 115 so that the compressed air outlet valve 195 can then be closed 330 to reduce leaks during the idle period.

The version of FIG. 7 has many possible uses. For example, when an operator of a tool or piece of equipment within or near a workstation 115 enters the workstation 115, the compressed air outlet valve 195 can automatically open and then close when there is no more presence detected. The user whose presence is detect can also be an individual, such as a patient in a hospital room, that is using equipment that used compressed air. In one particular use, a patient's presence can be detected, such as by detecting the weight of the patient in a hospital bed, and the compressed air can be made available accordingly.

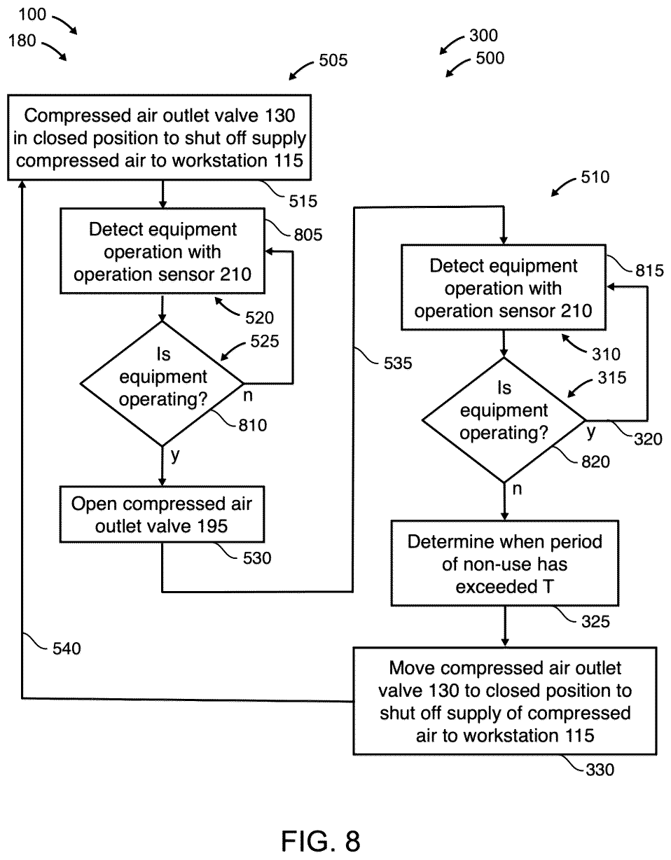

FIG. 8 illustrates another version of a compressed air delivery process 300 that can be performed using the compressed air delivery system 100 of the invention in accordance with the process 500 of FIG. 5. In the version of FIG. 8, the workstation use detector 185 of the compressed air delivery system 100 comprises an equipment operation sensing detector 205, such as an operation sensor 210, as discussed above, that senses 805 when a piece of equipment that uses compressed air is in operation. For example, some pieces of equipment have a motor and/or other moving part that vibrates or moves during operation, and the operation sensor can be positioned to detect such vibration or other movement as an indication that the piece of equipment is operating. With the process of FIG. 8, the compressed air will be automatically made available when the equipment is determined to be operating or starting to operate. When the operation of the equipment is detected 810, the compressed air outlet valve 195 is opened so that the supply of compressed air can be provided to the compressed air outlet 130 and provided to the equipment. The shut off process 510 for the version of FIG. 8 involves continuing to monitor 815 the operation sensor 210 to determine when the equipment is no longer being operated 820 so that the compressed air outlet valve 195 can then be closed 330 to reduce leaks during the idle period.

The version of FIG. 8 is particularly useful for equipment that utilizes compressed air but does not need compressed air to be turned on. This allows the piece of equipment to be turned on and to start to move before compressed air is supplied. The movement will trigger the supply of compressed air, and then the lack of movement will cause the supply of compressed air to be shut off by closing the compressed air outlet valve 195. The version of FIG. 8 can also be used with equipment that needs compressed air to begin operation. For example, a sticker or other visual indicated can be placed on the equipment in close proximity to the operation sensor 210 so that user can tap the area with their finger to trigger a movement sensor 220 or other sensor to initiate the flow of compressed air. A particular version of the tap indicator is shown in Appendix B of the provisional application.

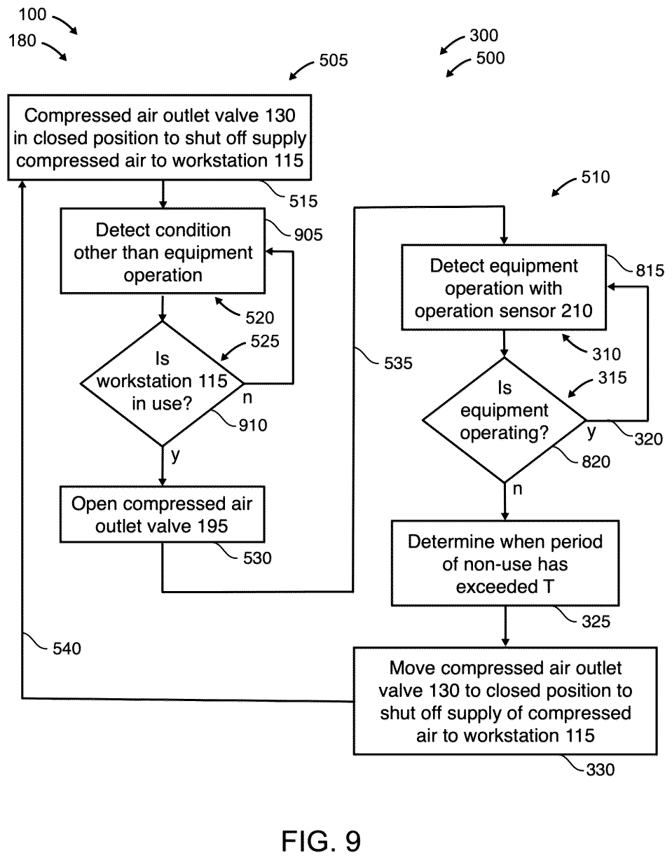

FIG. 9 illustrates another version of a compressed air delivery process 300 that can be performed using the compressed air delivery system 100 of the invention in accordance with the process 500 of FIG. 5. In the version of FIG. 9, a plurality of different types of detectors are used together. For example, a first type of detector can be used during the start up process 505, and a second type of detector can be used in the shut off process 510. This version can be particularly useful for equipment that needs compressed air in order to operate, but any combination of types of detectors can be used as best suits a particular situation. In the particular version shown in FIG. 9, a detector other than an equipment operation sensing detector is senses 905 when a workstation 115 is being used or when a piece of equipment is about to be used. For example, step 905 can be performed by an air hose movement sensing detector 215 and/or a user presence sensing detector 225, as discussed above, or with any other type of detector that can indicate that a workstation is being used without the need for compressed air to be supplied in order for a detection to be made. In one alternative version, the detector for detecting initial startup and/or continuous operation can be attached to a machine's relay or pump where it will trigger actuation of the compressed air when turned on and remain triggered due to the relays magnetic flux. This is also true for any coiled apparatus giving off a magnetic flux such as a CNC spindle. With the process of FIG. 9, the compressed air will be automatically made available when the workstation use is detected 910 by opening of the compressed air outlet valve 195. The shut off process 510 for the version of FIG. 9 involves monitoring 815 an operation sensor 210 to determine when the equipment is no longer being operated 820 so that the compressed air outlet valve 195 can then be closed 330 to reduce leaks during the idle period.

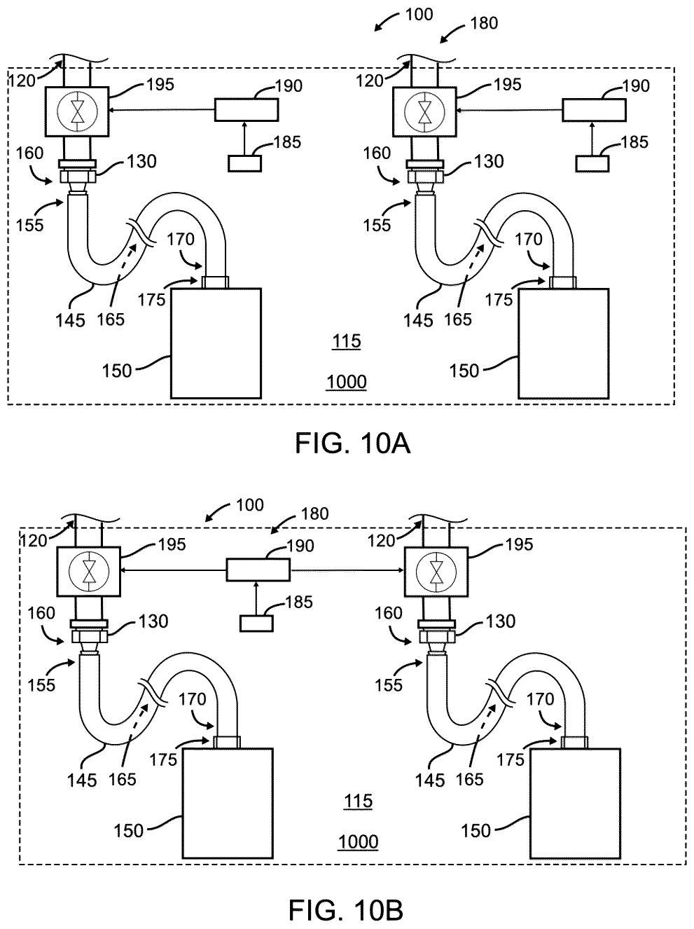

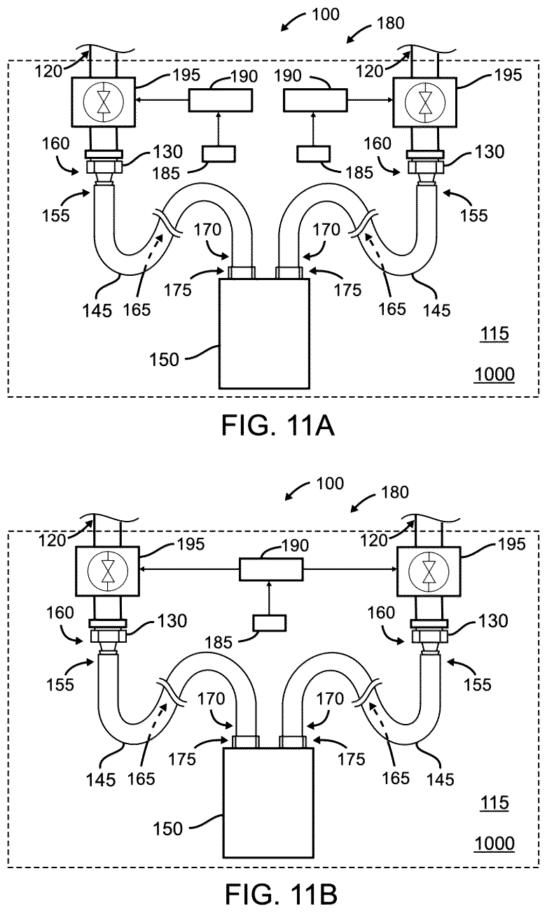

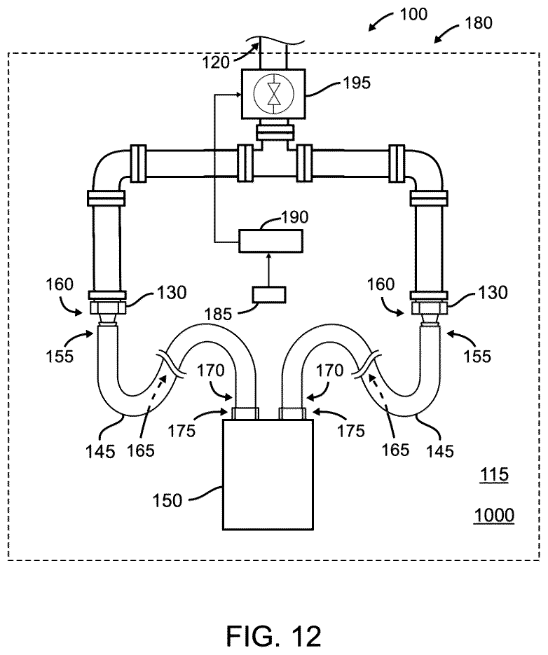

FIGS. 10A, 10B, 11A, 11B, and 12 shows versions of the compressed air delivery system 100 with a leak reduction system 180 that is useful in a facility 105 in which a workstation 115 is a multi-outlet workstation 1000. The multi-outlet workstation 1000 is a workstation 115 of the type described above with a plurality of compressed air outlets 130 in or near the workstation 115. In the version of FIGS. 10A and 10B, each of the plurality of compressed air outlets 130 is shown as being connected to a respective air hose 145 with each air hose being connected to a different object 150 that uses compressed air. In the version of FIG. 10A, a separate workstation use detector 185 is provided for each of the compressed air outlets 130, and each of the compressed air outlets can be independently controlled by the controller 190 in relation to the detections made by the respective workstation use detectors 185. In FIG. 10A, separate controllers are shown 190, but in another version a single controller 190 can receive signals from each of the workstation use detectors 185 and can provide separate control signals to each of the compressed air outlets 130. In the version of FIG. 10B, a single workstation use detector 185, which may itself be a single sensor or a plurality of sensors as discuss above, is used to control the operation of each of the compressed air outlets 130. In one particular version of the version of FIG. 10B, the control parameters for controlling the opening and closing of each of the compressed air outlet valves 195 is the same, so that all compressed air outlet valves 195 in the multi-outlet workstation 1000 are either open or closed in accordance with one of the herein-described processed. In another particular version of the version of FIG. 10B, the control parameters for each compressed air outlet are different and the controller 190 can independently control each of the compressed air outlet valves 195. In the version of FIGS. 11A and 11B, each air hose 145 is connected to the same object 150, such as a robotic device. FIG. 11A, like FIG. 10A, has a separate workstation use detector 185 associated with each compressed air outlet 130, and FIG. 11B, like FIG. 10B, uses the same workstation use detector 185 for each compressed air outlet valve 195. FIG. 12 shows a leak reduction system 180 similar to FIGS. 10B and 11B, but with a single compressed air outlet valve 195 controlling the supply of compressed air to each of the compressed air outlets 130 in the multi-outlet workstation 1000.

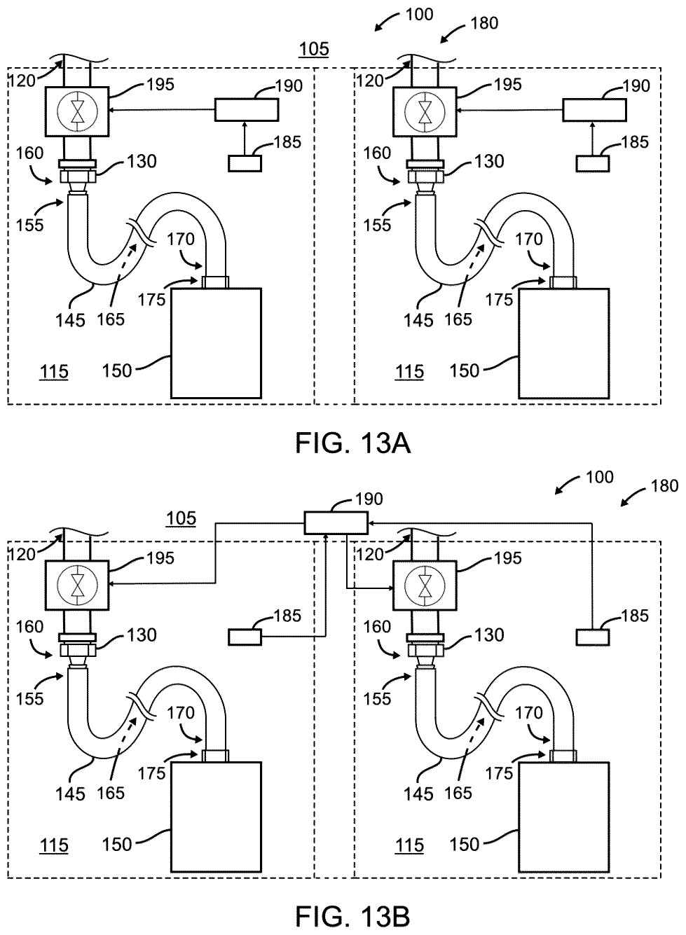

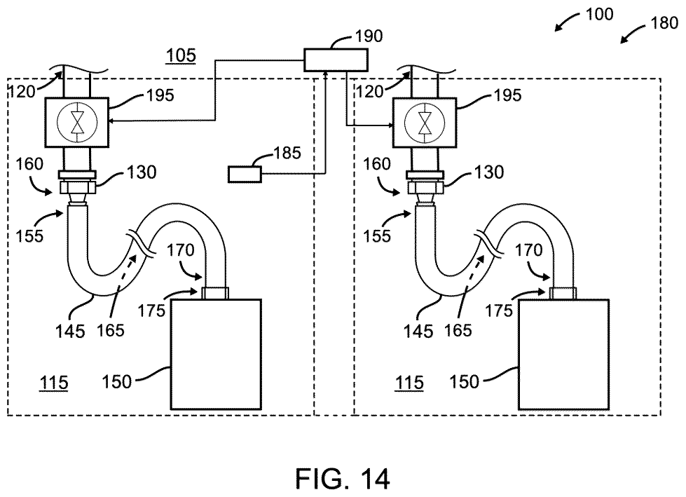

FIGS. 13A, 13B, and 14 shows versions of the compressed air delivery system 100 with a leak reduction system 180 that is useful in a facility 105 which has a plurality of separate workstations 115. In the version of FIG. 13A, a separate workstation use detector 185 is provided for each of the workstations 115, and each of the workstations 115 can be independently controlled by the controller 190 in relation to the detections made by the respective workstation use detectors 185. In FIG. 13A, separate controllers are shown 190. In the version of FIG. 13B, a single controller 190 can receive signals from each of the workstation use detectors 185 and can provide separate control signals to each of the workstations 115. In the version of FIG. 14, a workstation use detector 185 in one of the workstations 115, which may itself be a single sensor or a plurality of sensors as discuss above, is used to control the operation of multiple workstations 115. In one particular version of the version of FIG. 14, the control parameters for controlling the opening and closing of each of the workstations 115 is the same, so that all compressed air outlet valves 195 in the multiple workstations 115 are either open or closed in accordance with one of the herein-described processed. In another particular version of the version of FIG. 14, the control parameters for each workstation 115 are different and the controller 190 can independently control each of the workstations.

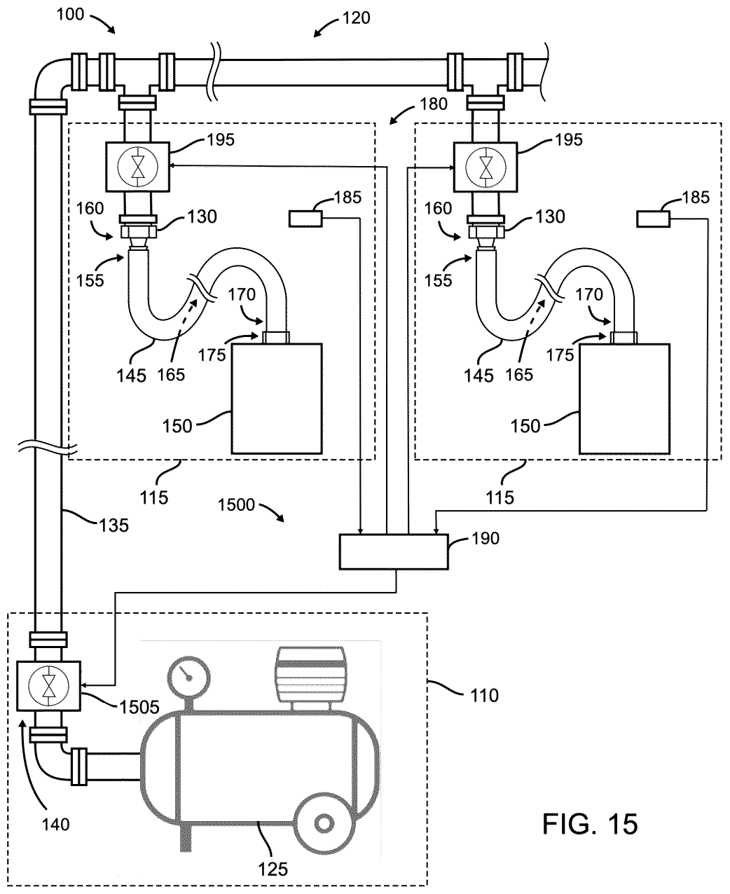

FIG. 15 shows another version of a compressed air delivery system 100 that is useful in a facility 105 which has a plurality of workstations 115. In the version of FIG. 15, the leak reduction system 180 includes a main valve shut off system 1500. In the main valve shut off system 100, the piping system shut off valve 140 is an electronically controllable valve 1505 which can be operationally similar to the compressed air outlet valves 195 in the workstations 115. When the controller 190 detects that all workstations 115 in the facility 105 are not in use, the controller 190 will send a single to close the piping system shut off valve 140 by closing the electronically controllable valve 1505. This version provides added leak prevention by reducing or substantially eliminating any leaks in the piping system 120 between the piping system shut off valve 140 and the compressed air outlets 130 in addition to the leaks downstream from the compressed air outlets 130. In one version, the compressed air delivery system 100 will have one or a plurality of air compressors 125 in the central air compression region 110, and the one or plurality of air compressors 125 will feed the same piping system 120, and the piping system shut off valve 140 will shut off compressed air supply to all compressed air outlets 130. In another version, a plurality of air compressor 125 may be provided, and each air compressor 125 supplies compressed air to its own piping system 120. In this version, there will be a piping system shut off valve 140 associated with each piping system 120. When the FIG. 15 version is applied to this multi-piping system 120 version, each of the piping system shut off valves 140 would be independently automatically closed when all compressed air outlets 130 associated with a particular piping system 120 are determined to not be in use.

The compressed air delivery system 100 as described thus solves the problem of air leaks when a workstation 115 and/or equipment is not in use. While in use, leaks in the workstation 115 are not as large of a concern because there is already a large amount of compressed air being utilized. However, when a workstation 115 is not in use, especially for a long period of time, the loss from leaks and the resulting energy required to compensate for the loss can quickly add up. By being able to close the compressed air outlet valves 195, these idle time leaks can be greatly reduced or substantially eliminated, which can result in substantial cost and energy savings in that the one or more air compressors 125 will not have to compress as much air unnecessarily.

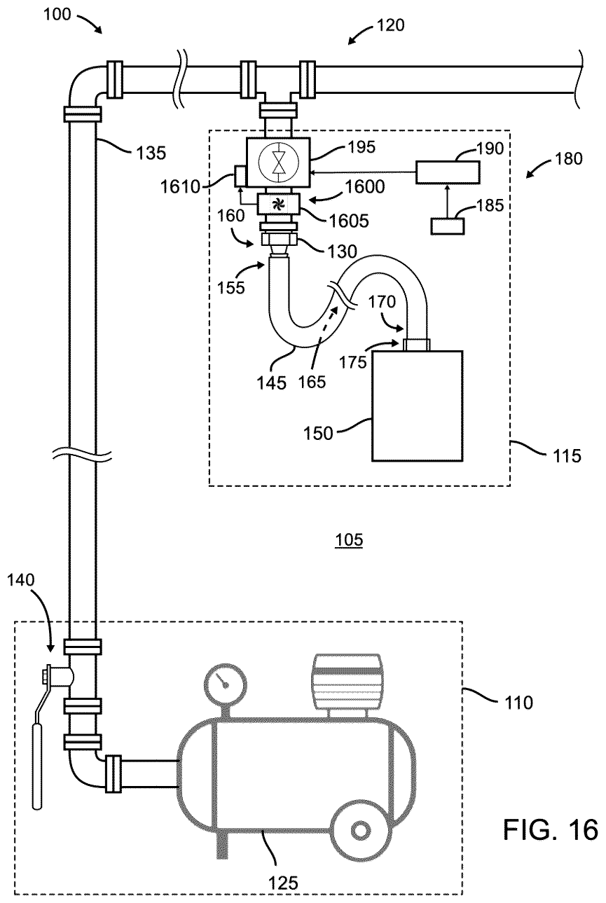

FIG. 16 shows another version of a compressed air delivery system 100 of the invention. In the version of FIG. 16, the compressed air delivery system 100 comprises a valve recharging system 1600. As can be seen in FIG. 16, one or more charging turbines 1605 can be positioned in line with one or more of the compressed air outlet valves 195. When the compressed air outlet valve 195 is open and air is allowed to flow through the associated compressed air outlet 130, the air also flows through the charging turbine 1605 to cause a propeller within the charging turbine to rotate. The charging turbine 1605 operates as a DC motor and energy from the rotating propeller into is used to charge one or more batteries 1610 that are used to power the operation of the compressed air outlet valve 195. In FIG. 16, the charging turbine 1605 is shown downstream of the compressed air outlet valve 195, but it can be positioned upstream or any other position in the air flow. The system of FIG. 16 is thus able to self-charge and the compressed air outlet valve 195 can operate regeneratively for years.

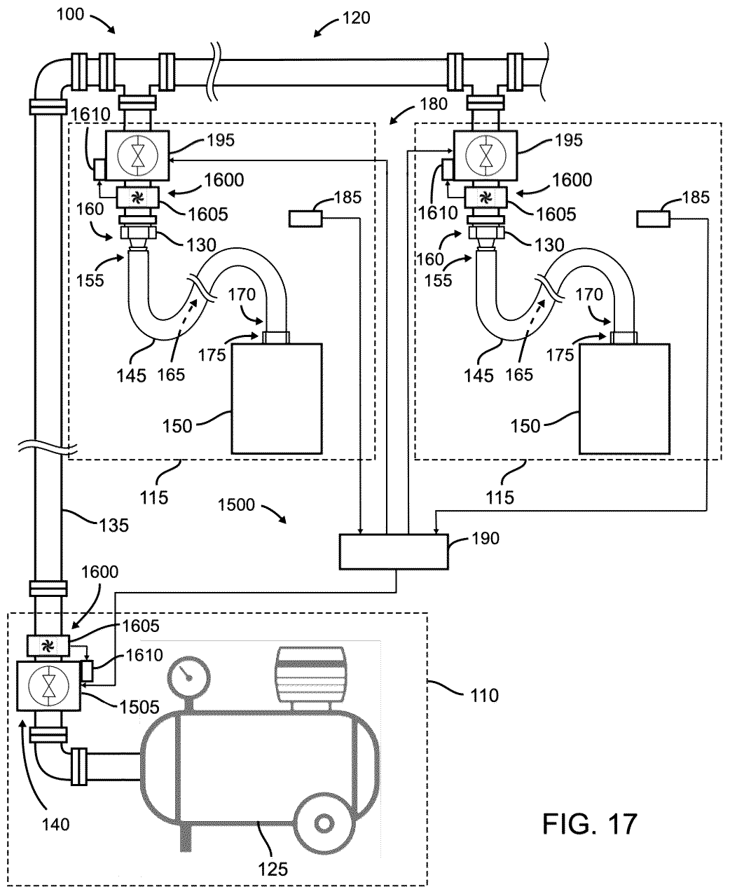

FIG. 17 shows another version of a compressed air delivery system 100 similar to the version of FIG. 16. In the version of FIG. 17, one or more charging turbines 1605 are provided for a plurality of compressed air outlet valves 195, such as compressed air outlet valves 195 in different workstations 115 or as otherwise described herein. Additionally or alternatively, as also shown in FIG. 17, a charging turbine 1605 can be provided for the electronically controllable piping system shut off valve 1505.

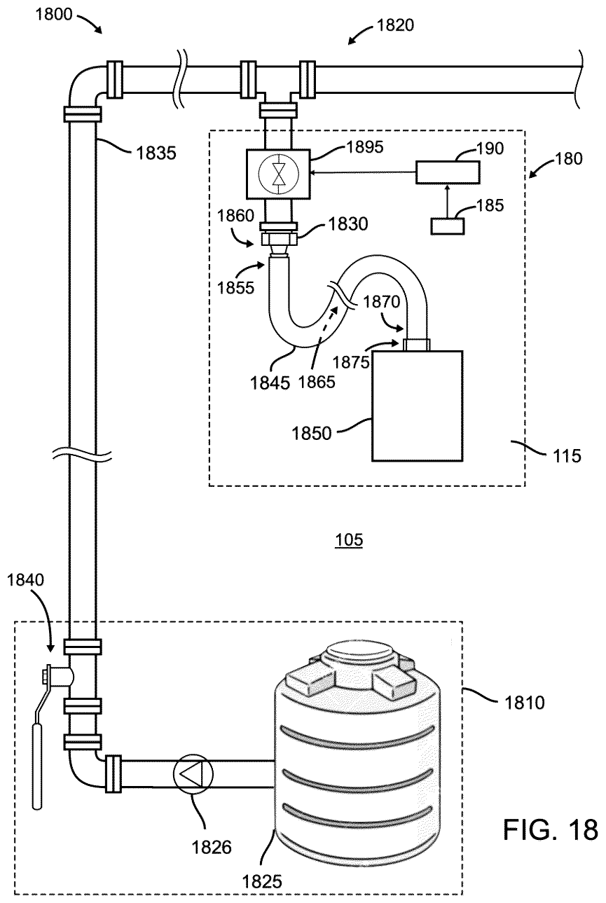

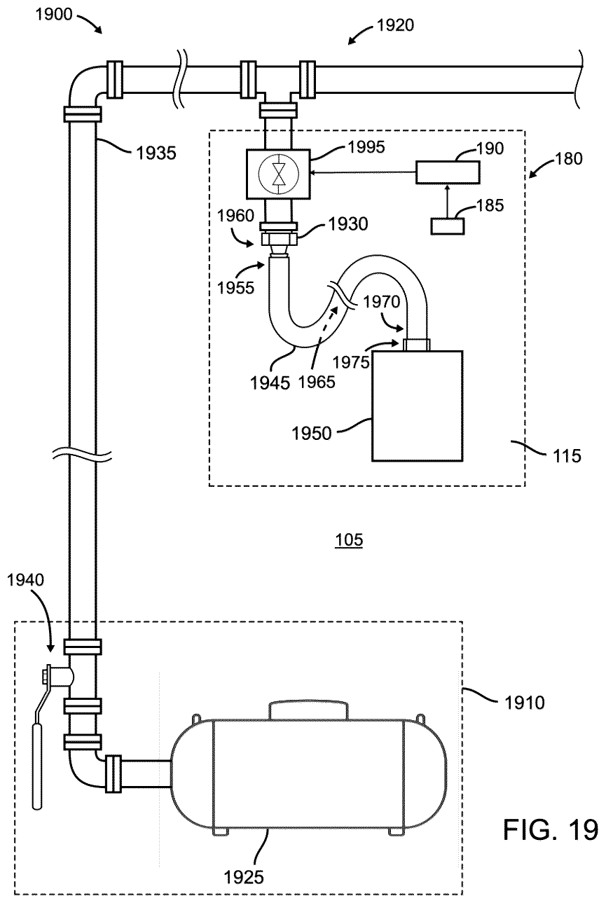

FIGS. 1-17 illustrate various versions and methods of a fluid delivery system that delivers compressed air using a compressed air delivery system 100. However, compressed air is only an example of a fluid that can be delivered in a system in accordance with the invention. The invention is particularly useful for a fluid delivery system that includes a series of soft lines that are connected to a hard line system. By being able to shut off flow at or near the connection of the soft lines to the hard lines, the loss of fluid from leaks can be greatly reduced. For example, FIGS. 18 and 19 show additional fluid delivery systems in accordance with the invention.

FIG. 18 shows a fluid delivery system in the form of a water delivery system 1800 that is capable of delivering water or other liquid to a workstation 115 in a facility 105. The water delivery system 1800 is provided within a facility 105 that utilizes water in operation, such as an industrial facility, garage, shop, hospital or other medical facility, or the like. Often water will be provided alongside compressed air in a workstation 115. The water delivery system 1800 delivers water from a central water area 1810 to the one or more workstations 115.

The water delivery system 1800 includes a water piping system 1820 that provides water from the central water area 1810 to one or more workstations 115 in the facility 105. The water piping system 1820 connects a source of water 1825 in the central water area 1810 to one or more water outlets 1830 in or near one or more workstations 115. The source of water 1825 can be a tank or can be from a public source or a well. A pump 1826 may optionally be provided if necessary to cause water to flow through the water piping system 1820. Alternatively, the water may flow by other influence, such as gravity or external pump. A chiller and/or a water heater may also optionally be provided for facilities in need or cold and/or hot water. A system of pipes and pipe connectors or joints 1835 form sealed conduits that contain the water and make the water available at the one or more water outlets 1830. The water piping system 1820 is typically, but need not necessarily be, made of hard or rigid piping, such as copper, steel, iron, PVC, or the like. Because the water piping system 1820 is a fixed structure that does not need to move or be flexible, the piping system 1820 can be robustly constructed so that leaks are minimized. A water piping system shut off valve 1840 may be provided, either in the central water area 1810 or downstream thereof, to selectively shut off the delivery of the water to the rest of the one or more water outlets 1830 when desired, such as when the facility 105 is not in operation or when the water piping system 1820 is being repaired.

Within or near the workstation 115, a water hose 1845 or soft line is used to receive water from a water outlet 1830 and deliver the water to an object 1850 that utilizes the water. The object 1850 can be, for example, a piece of equipment or tool that uses water to operate or can be a nozzle or dispenser that allows a user to selectively release water from the water hose 1845. The water hose 1845 has a first end 1855 with a component that cooperates with a water outlet 1830 to form a water outlet coupler 1860 that connects the first end 1855 of the water hose 1845 to the water outlet 1830 in a manner that allows the water to flow through an interior lumen 1865 of the water hose 1845 to a second end 1870 of the water hose 1845. The second end 1870 of the water hose 1845 has a component that cooperates with a component of the object 1850 to form an object coupler 1875 that connects the second end 1870 of the water hose 1845 to the object 1850 in or near the workstation 115 in a manner that delivers water to the object 1850 for the operation of the object 1850 and/or for selective dispensing of the water by an operator or other device. The water hose 1845, water outlet coupler 1860, and object coupler 1875 can be any conventional and/or commercially available type or any newly developed components. Typically, the water hose 1845 will be made of one or more of thermoplastic rubber, PVC, polyurethane, static dissipative polyurethane, neoprene, silicone, polyethylene, fabric, and the like, and will be equipped with a threads that mate with threads on the water outlet 1830 to together form the water outlet coupler 1860 and a threaded object connecter that mates with a threaded component on the object 1850 to together form the object coupler 1875, but the hose and couplers can be any other suitable arrangement, such as a quick connect type of coupling.

The water supply system downstream of the water outlet 1830 is more prone to water leaks than the water piping system 1820 that is upstream of the water outlet 1830. The water outlet coupler 1860 and/or the object coupler 1875, which are often designed to be easily releasable and/or which rely on leak-prone threads, are particularly subject to leaking especially after prolonged use. The water hose 1845 due to its flexible nature and the object 1850, which may have numerous moving parts, are also susceptible to leaks. Accordingly, the water delivery system 1800 of this version of the invention includes a leak reduction system 180, such as one or more of the versions of the leak reduction system 180 described above in connection with the compressed air delivery system 100, designed to reduce the loss of water from one or more leaks in or near a workstation 115, particularly downstream of a water outlet 1830.

As can be seen in the version of FIG. 18, the leak reduction system 180 comprises a workstation use detector 185 that communicates with a controller 190 which controls the operation of a water outlet valve 1895 that operates in the same manner as the compressed air outlet valve 195 described above but specifically designed for water valving and that is positioned and adapted to control whether or not water is delivered to a water outlet 1830 from the water piping system 1820. The water outlet valve 1895 is thus responsive to the workstation use detector 185. For example, in one version, the workstation use detector detects a condition in or near the workstation 115 and/or on or near the object 1850 or water hose 1845 and sends a signal to the controller 190 which makes an assessment as to whether or not the object 1850 is in use and/or whether or not the workstation 115 is in need of having water supplied to and available from the water outlet 1830. If the water is determined to be unneeded, a signal is sent from the controller 190 to the water outlet valve 1895 to cause the water outlet valve 1895 to close thereby shutting off the supply of water from the water piping system 1820 to the water outlet 1830. By being shut off, no water is delivered to the water hose 1845 or the object 1850 when the water is not needed. As a result, there is a reduced loss of water from leaks that exists downstream of the water outlet 130. In the absence of the shut off, water would be present in the water hose 1845 and object 1850 while the workstation 115 is idle, and some water may escape through leaks in, for example, the water hose 1845, object 1850, water outlet coupler 1860, and/or object coupler 1875, and that escaped water will be lost and wasted. By reducing or eliminating the leaks by shutting off the supply of water to the leak-prone regions, the water consumption in the facility 105 can be greatly reduced. The leak reduction system 180 thus operates to conserve water and also to conserve energy from pumps, chillers, heaters, and other components associates with the delivery of water.

FIG. 19 shows a fluid delivery system in the form of a gas delivery system 1900 that is capable of delivering a gas, such as air or compressed air, as discussed above, or other gas often used in a medical setting, such as oxygen, nitrous oxide, nitric oxide, and mixtures thereof, and fuel gases, such as natural gas and propane to a workstation 115 in a facility 105. The gas delivery system 1900 is provided within a facility 105 that utilizes gas in operation, such as an industrial facility, garage, shop, hospital or other medical facility, or the like. Often multiple gas lines will be provided alongside one another in a workstation 115. The gas delivery system 1900 delivers gas from a central gas area 1910 to the one or more workstations 115.

The gas delivery system 1900 includes a gas piping system 1920 that provides gas from the central gas area 1910 to one or more workstations 115 in the facility 105. The gas piping system 1920 connects a source of gas 1925 in the central gas area 1910 to one or more gas outlets 1930 in or near one or more workstations 115. The source of gas 1925 can be a tank or commercial or public line. A chiller, heater, compressor, pressurizer, or the like may also optionally be provided for certain facilities. A system of pipes and pipe connectors or joints 1935 form sealed conduits that contain the gas and make the gas available at the one or more gas outlets 1930. The gas piping system 1920 is typically, but need not necessarily be, made of hard or rigid piping, such as copper, steel, iron, brass, aluminum, PVC, or the like. Because the gas piping system 1920 is a fixed structure that does not need to move or be flexible, the gas piping system 1920 can be robustly constructed so that leaks are minimized. A gas piping system shut off valve 1940 may be provided, either in the central gas area 1910 or downstream thereof, to selectively shut off the delivery of the gas to the rest of the one or more gas outlets 1930 when desired, such as when the facility 105 is not in operation or when the gas piping system 1920 is being repaired.

Within or near the workstation 115, a gas hose or tube 1945 or soft line is used to receive gas from a gas outlet 1930 and deliver the gas to an object 1950 that utilizes the gas. The object 1950 can be, for example, a piece of equipment or tool that uses gas to operate or can be a nozzle or dispenser that allows a user to selectively release gas from the gas hose or tube 1945. For example, in one version, the object 1950 can be a mask or nose tube that is adapted to deliver gas to a patient in a medical setting. The gas hose or tube 1945 has a first end 1955 with a component that cooperates with a gas outlet 1930 to form a gas outlet coupler 1960 that connects the first end 1955 of the gas hose or tube 1945 to the gas outlet 1930 in a manner that allows the gas to flow through an interior lumen 1965 of the gas hose or tube 1945 to a second end 1970 of the gas hose or tube 1945. The second end 1970 of the gas hose or tube 1945 has a component that cooperates with a component of the object 1950 to form an object coupler 1975 that connects the second end 1970 of the gas hose or tube 1945 to the object 1950 in or near the workstation 115 in a manner that delivers gas to the object 1950 for the operation of the object 1950 and/or for selective dispensing of the gas by an operator or other device. The gas hose or tube 1945, gas outlet coupler 1960, and object coupler 1975 can be any conventional and/or commercially available type or any newly developed components. Typically, the gas hose or tube 1945 will be made of one or more of thermoplastic rubber, silicone, PVC, polyethylene, polyurethane, and the like.

The gas supply system downstream of the gas outlet 1930 is more prone to gas leaks than the gas piping system 1920 that is upstream of the gas outlet 1930. The gas outlet coupler 1960 and/or the object coupler 1975, which are often designed to be easily releasable and/or which may rely on leak-prone threads, are particularly subject to leaking especially after prolonged use. The gas hose or tube 1945 due to its flexible nature and the object 1950, which may have numerous moving parts, are also susceptible to leaks. Accordingly, the gas delivery system 1900 of this version of the invention includes a leak reduction system 180, such as one or more of the versions of the leak reduction system 180 described above in connection with the compressed air delivery system 100, designed to reduce the loss of gas from one or more leaks in or near a workstation 115, particularly downstream of a gas outlet 1930.

As can be seen in the version of FIG. 19, the leak reduction system 180 comprises a workstation use detector 185 that communicates with a controller 190 which controls the operation of a gas outlet valve 1995 that operates in the same manner as the compressed air outlet valve 195 described above but designed to be useable with a particular gas to be delivered and that is positioned and adapted to control whether or not gas is delivered to a gas outlet 1930 from the gas piping system 1920. The gas outlet valve 1995 is thus responsive to the workstation use detector 185. For example, in one version, the workstation use detector detects a condition in or near the workstation 115 and/or on or near the object 1950 or gas hose or tube 1945 and sends a signal to the controller 190 which makes an assessment as to whether or not the object 1950 is in use and/or whether or not the workstation 115 is in need of having gas supplied to and available from the gas outlet 1930. If the gas is determined to be unneeded, a signal is sent from the controller 190 to the gas outlet valve 1995 to cause the gas outlet valve 1995 to close thereby shutting off the supply of gas from the gas piping system 1920 to the gas outlet 1930. By being shut off, no gas is delivered to the gas hose or tube 1945 or the object 1950 when the gas is not needed. As a result, there is a reduced loss of gas from leaks that exists downstream of the gas outlet 1930. In the absence of the shut off, gas would be present in the gas hose or tube 1945 and object 1950 while the workstation 115 is idle, and some gas may escape through leaks in, for example, the gas hose or tube 1945, object 1950, gas outlet coupler 1960, and/or object coupler 1975, and that escaped gas will be lost and wasted. By reducing or eliminating the leaks by shutting off the supply of gas to the leak-prone regions, the gas consumption in the facility 105 can be greatly reduced. The leak reduction system 180 thus operates to conserve gas and also to conserve energy from equipment and other components associates with the delivery of gas.

Any of the various versions or methods described and shown in FIGS. 2 through 17 in connection with the compressed air delivery system 100 can be used in connection with the other fluid delivery systems, such as the ones shown in FIGS. 18 and 19, with the necessary adjustments being made for the fluid being delivered. In addition, and of the fluid delivery systems described herein can be used in combination and/or conjunction with one another and can be used with shared or independently operating workstation use detectors 185 and/or controllers 190. For example, a workstation 115 in a facility can have a compressed air outlet 130 and a water outlet 1830, and the workstation can have a workstation use detector 185 associated with the compressed air outlet 130 and different workstation use detector 185 associated with the water outlet, or it can have a workstation use detector 185 that is used for controlling both the compressed air outlet 130 and the water outlet 1830. Similarly, for the gas delivery system, 1900, a workstation may have multiple different gas outlets 1930, each in communication with a different gas source having its own piping system. In this workstation, too, there can be multiple respective workstation use detectors 185 or a single workstation use detector 185. Similarly, for a charging turbine 1605, the spinning of the propeller and the associated resistance can be adjusted for air, water, gas or other fluid flow.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person of ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and to include zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A compressed air delivery system comprising:
a source of pressurized air;
a piping system adapted to deliver pressurized air from the source of pressurized air to a compressed air outlet in or accessible from a workstation;
a pneumatic object in or accessible from the workstation, wherein the pneumatic object utilizes compressed air and is connectable to the compressed air outlet; and
a leak reduction system, the leak reduction system comprising a workstation use detector, a controller, and a compressed air outlet valve adapted to be moveable between an open position where compressed air flows through the compressed air outlet and a closed position where compressed air does not flow through the compressed air outlet,
wherein the workstation use detector provides a workstation use signal related to whether or not the workstation is in use to the controller, and wherein the controller controls operation of the compressed air outlet valve in response to the signal.

2. A compressed air delivery system according to claim 1 wherein the controller determines from the workstation use signal if the workstation is not in use, and wherein if the workstation is determined to not be in use for a predetermined period of time, the controller places the compressed air outlet valve in the closed position.

3. A compressed air delivery system according to claim 1 wherein the controller determines from the workstation use signal if the workstation is not in use, wherein if the workstation is determined to not be in use for a predetermined period of time, the controller places the compressed air outlet valve in the closed position, and wherein if the controller determines from the workstation use signal that the workstation is in use, the controller places the compressed air outlet valve in the open position.

4. A compressed air delivery system according to claim 1 wherein the pneumatic object is a piece of equipment, wherein the workstation use detector comprises an equipment operation sensing detector, and wherein the workstation use signal is related to the operation of the equipment.

5. A compressed air delivery system according to claim 4 wherein the equipment operation sensing detector comprises an indicator on the equipment for a position on the equipment for a user to tap and a sensor for detecting the tap.

6. A compressed air delivery system according to claim 4 wherein the equipment operation sensing detector comprises one or more of a vibration sensor, an accelerometer, an ultrasonic sensor, a magnetic flux sensor, a temperature sensor, and a humidity sensor, that detects operation of the equipment and provides sufficient information to the controller to enable the controller to determine if the equipment is operating or is not operating.

7. A compressed air delivery system according to claim 1 wherein an air hose connects the compressed air outlet and to the pneumatic object, wherein the workstation use detector comprises an air hose movement detector, and wherein the workstation use signal is related to the movement of the air hose.

8. A compressed air delivery system according to claim 7 wherein the air hose movement detector comprises a movement sensor comprising one or more of a vibration sensor, an accelerometer, an optical movement sensor, an ultrasonic movement sensor, a magnetic flux sensor, a pressure sensor, and a temperature sensor that detects movement of the air hose and provides sufficient information to the controller to enable the controller to determine if the air hose is in operation or is not in operation.

9. A compressed air delivery system according to claim 1 wherein the workstation use detector comprises a presence sensing detector and wherein the workstation use signal is related to a presence in the workstation.

10. A compressed air delivery system according to claim 9 wherein the presence sensing detector comprises a presence sensor comprising one or more of a motion detector, a temperature detector, a weight detector, and a wearable signal generator that detects presence in the workstation and provides sufficient information to the controller to enable the controller to determine if there is presence in the workstation or not.

11. A compressed air delivery system according to claim 1 wherein the workstation use detector comprises two or more of an equipment operation detector, an air hose movement detector, and a presence sensing detector.

12. A compressed air delivery system according to claim 1 wherein the piping system is adapted to deliver pressurized air from the source of pressurized air to a plurality of compressed air outlets in the workstation, wherein each compressed air outlet is associated with a compressed air outlet valve, and wherein the controller controls operation of each of the compressed air outlets in response to the signal.

13. A compressed air delivery system according to claim 1 wherein the workstation is a first workstation and the compressed air outlet is in or near the first workstation, wherein the piping system is adapted to deliver pressurized air from the source of pressurize air to a second compressed air outlet in or near a second workstation, wherein the leak reduction system comprises a first workstation use detector and a second workstation use detector.

14. A compressed air delivery system according to claim 1 wherein the workstation is a piece of equipment.

15. A leak reduction system for use with a compressed air delivery system comprising a source of pressurized air; a piping system adapted to deliver pressurized air from the source of pressurized air to a workstation; a compressed air outlet in or near the workstation; a pneumatic object that utilizes compressed air, the pneumatic object being connectable to the compressed air outlet, the leak reduction system comprising:
a workstation use detector,
a controller, and
a compressed air outlet valve adapted to be moveable between an open position where compressed air is allowed to flow through the compressed air outlet and a closed position where compressed air is not permitted to flow through the compressed air outlet,
wherein the workstation use detector provides a workstation use signal related to whether or not the workstation is in use to the controller, and wherein the controller controls operation of the compressed air outlet valve in response to the signal.

16. A leak reduction system according to claim 15 wherein the controller determines from the workstation use signal if the workstation is not in use, wherein if the workstation is determined to not be in use for a predetermined period of time, the controller places the compressed air outlet valve in the closed position, and wherein if the controller determines from the workstation use signal that the workstation is in use, the controller places the compressed air outlet valve in the open position.

17. A leak reduction system according to claim 15 wherein the workstation use detector comprises one or more of an equipment operation sensing detector, an air hose movement detector, and a presence sensing detector.

18. A method of reducing leaks in a compressed air delivery system in which compressed air is delivered to a workstation including a pneumatic object that utilizes compressed air, the method comprising:
detecting a condition related to workstation use;
determining whether or not the workstation is in use from the detected condition;
if the workstation is determined to be in use, allowing compressed air to flow to the pneumatic object; and
if the workstation is determined to not be in use, preventing compressed air from flowing to the pneumatic object.

19. A method according to claim 18 wherein the step of determining whether or not the workstation is in use comprises determining an amount of time the workstation has not been in use.

20. A method according to claim 18 wherein the step of detecting a condition related to workstation use comprises detecting one or more of operation of the pneumatic object, movement of an air hose connectable to the pneumatic object, and a presence in the workstation.
